(19) United States
(12) Patent Application Publication
(10) Pub. No.: US 2026/0202046 A1
(43) Pub. Date: Jul. 16, 2026

(54) LIGHTING SYSTEMS INTEGRATING LANDSCAPE LIGHTS AND STRIP LIGHTING

(71) Applicant: Park City Light L.L.C., West Jordan, UT (US)

(72) Inventors: Drew Buck, West Jordan, UT (US); Sean Matz, Riverton, UT (US); Dan Oakeson, West Jordan, UT (US)

(73) Assignee: Park City Light L.L.C., West Jordan, UT (US)

(21) Appl. No.: 19/452,009

(22) Filed: Jan. 16, 2026

Related U.S. Application Data
(60) Provisional application No. 63/745,994, filed on Jan. 16, 2025.

(51) Int. Cl. F21V 23/02; F21S 4/00; F21S 8/08; F21V 23/04; F21V 23/06

(52) U.S. Cl. CPC F21V 23/02; F21S 4/00; F21S 8/081; F21V 23/0435; F21V 23/06

(57) ABSTRACT

This disclosure relates generally to lighting systems that seamlessly integrate strip lights having a first power requirement into a landscape lighting system having a second, different power requirement. For example, a lighting system may include a plurality of strip lights to be installed on a building and a plurality of landscape lights to be installed at landscape elements about the building. The lighting system may also include a converter in electrical connection with the plurality of strip lights, where the converter is for supplying power to the plurality of strip lights. Further, the lighting system may include a controller for controlling a light output of the plurality of strip lights. A light output of the plurality of strip lights may be controlled by the controller.

### RELATED APPLICATIONS

This application claims priority to U.S. Provisional Patent Application Ser. No. 63/745,994 (Attorney Docket No. 39118.8) filed Jan. 16, 2025, entitled LIGHTING SYSTEMS INTEGRATING LANDSCAPE LIGHTS AND STRIP LIGHTING, the entire disclosure of which is hereby incorporated by reference.

### TECHNICAL FIELD

This disclosure relates generally to lighting systems that seamlessly integrate strip lights having a first power requirement into a landscape lighting system having a second, different power requirement.

### SUMMARY

Disclosed are systems, devices, and/or methods of use thereof regarding lighting systems that seamlessly integrate strip lights having a first power requirement into a landscape lighting system having a second, different power requirement. In one embodiment, the systems may integrate 24 VDC LED strip lights into a 12 VAC LED landscape lighting system. In various aspects, an outdoor lighting system includes a plurality of strip lights to be installed on a building (e.g., the building itself, stairs, railways, decks, seating areas, walls, wall capstones, etc.), where the plurality of strip lights are powered at a first power level. The outdoor lighting system may also include a plurality of landscape lights to be installed at a plurality of landscape elements, where the plurality of landscape lights are powered at a second power level, the second power level being different than the first power level. The outdoor lighting system may further include a converter in connection with the plurality of strip lights, where the converter is for providing the first power level to the plurality of strip lights. Further, the outdoor lighting system may include a controller for controlling a light output of the plurality of strip lights.

In various aspects, a lighting system includes a plurality of strip lights to be installed on a building (e.g., the building itself, stairs, railways, decks, seating areas, walls, wall capstones, etc.) and a plurality of landscape lights to be installed at landscape elements about the building. The lighting system may also include a converter in electrical connection with the plurality of strip lights, where the converter is for supplying power to the plurality of 24 VDC LED strip lights. Further, the lighting system may include a controller for controlling a light output of the plurality of strip lights.

In various aspects, a method of powering strip lights and landscape lights may include connecting a converter to a plurality of strip lights, where the plurality of strip lights are to be installed on a building (e.g., the building itself, stairs, railways, decks, seating areas, walls, wall capstones, etc.) and the plurality of landscape lights are to be installed at a plurality of landscape elements in connection with the building. The method may also include providing an initial power level to the converter and converting, by the converter, the initial power level to a first power level to power the plurality of strip lights. Additionally, the method may include powering the plurality of landscape lights at the initial power level, with the initial power level being different than the first power level. Further, the method may include controlling a light output of the plurality of strip lights.

In at least some implementations, a landscape lighting distribution is used as a safe, NEC-compliant backbone to power 24 VDC architectural strip lighting, without introducing line voltage and without requiring an electrician.

At least some implementations relate to a voltage-bridge system, wherein a lighting system uses a low-voltage landscape lighting transformer and cabling to distribute power to a remote converter that locally supplies industry standard 24 VDC LED strip lighting.

In at least some implementations, a shared infrastructure is used wherein a converter receives power from the same low-voltage transformer that powers landscape lighting fixtures.

In at least some implementations, no line-voltage is present downstream of the landscape lighting transformer.

In at least some implementations, the system is configured to retrofit an existing landscape lighting installation to supply 24 VDC strip lighting without modification of line-voltage wiring.

In at least some implementations, a plurality of converters are connected to a single landscape lighting transformer to supply 24 VDC strip lighting at multiple locations.

In at least some implementations, the system is configured to retrofit an existing landscape lighting installation to supply 24 VDC strip lighting without modification of line-voltage wiring.

Other aspects of the disclosed subject matter, as well as features and advantages of various aspects of the disclosed subject matter, should be apparent to those of ordinary skill in the art through consideration of the ensuing description, the accompanying drawings, and the appended claims.

While the methods and processes of the present disclosure have proven to be particularly useful in the area of integrating landscape lights and strip lighting, those skilled in the art can appreciate that the methods and processes can be used in a variety of different applications.

These and other features and advantages of the present disclosure will be set forth or will become more fully apparent in the description that follows and in the appended claims. The features and advantages may be realized and obtained by means of the aspects and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present disclosure are obtained, a more particular description of the disclosure will be rendered by reference to specific embodiments thereof, which are illustrated in the appended drawings. Understanding that the drawings depict only representative embodiments of the present invention and are not, therefore, to be considered as limiting the scope of the invention, the present description will be described and explained with additional specificity and detail through the use of the accompanying drawings in which:

FIG. 1 illustrates a lighting system including a plurality of strip lights, a plurality of landscape lights, a converter, a transformer for supplying power to the converters and the plurality of landscape lights, and a controller;

FIG. 2 provides a flowchart of power flow through the lighting system of FIG. 1;

FIG. 3 illustrates the converter from the system of FIG. 1;

FIG. 4 illustrates a close up view of the converter;

FIG. 5 schematically illustrates a block diagram of a controller for the converter; and

FIG. 6 is a flowchart of an example method of powering a lighting system, such as the lighting system of FIG. 1.

### DETAILED DESCRIPTION

Typically, strip lights that are installed on buildings (e.g., the building itself, stairs, railways, decks, seating areas, walls, wall capstones, etc.) require a 120-volt (V) AC power connection. To install strip lights having this power requirement, an electrician or other skilled technician is required. Additionally, strip lights having this power requirement cannot be seamlessly integrated into a landscape lighting system that is powered by a 12 VAC power. Traditionally, landscapers and low-voltage lighting contractors without electrical licenses have relied on 120 VAC to 24 VDC transformers to power LED strip lights that operate on a direct current voltage of 24 volts (24 VDC strip lights). This required them to locate a nearby 120-volt power source or hire an electrician to extend power to the site. Additionally, they faced the challenge of integrating the strip lighting with the existing 12 VAC low-voltage landscape lighting system, often requiring the use of relays, 24 VDC transformers, or separate timers to manage the setup.

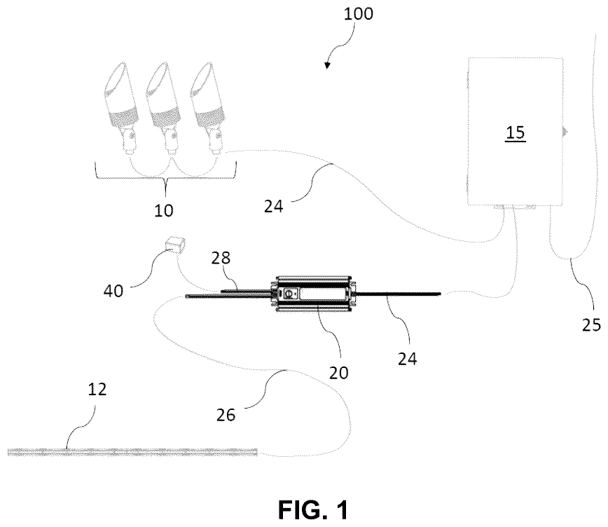

FIG. 1 illustrates a system 100 including a plurality of strip lights to be installed on a building (e.g., the building itself, stairs, railways, decks, seating areas, walls, wall capstones, etc.) and a plurality of landscape lights installed at landscape elements in connection with the building (e.g., surrounding the building, etc.). As illustrated, the system 100 includes a transformer 15 for receiving power from a 120 VAC power source (e.g., the building's power source), a converter 20 in electrical connection with the transformer 15, a plurality of landscape lights 10 in electrical connection with the transformer 15, a plurality of strip lights 12 in electrical connection with the converter 20, and a controller 40 in electrical connection with the converter 20. The controller 40 may be a 0-10 volt standard dimmer or other type of suitable controller desired. The converter 20 and the plurality of landscape lights 10 may each be in electrical communication with the transformer 15 through input wires or cables 24, which may be 12 VAC cables. The plurality of strip lights 12 may be in electrical communication with the converter 20 through output wires or cables 28, which may be 24 VDC cables. Accordingly, the converter 20 may act as a volt bridge between the transformer and the plurality of strip lights 12.

The disclosed system 100 addresses the challenge of powering 24 VDC LED strip lights 12 in outdoor locations without requiring 120-volt AC power or a licensed electrician. The system 100 incorporates the converter 20 that simplifies the process by converting 12 VAC to 24 VDC and optionally integrating the controller 40 (e.g., a dimmer). This enables landscapers and low voltage lighting contractors to install LED lighting on stairs, benches, railings, walls, porches, gazebos, and more using low-voltage wiring (e.g., 24 VDC wiring). By eliminating the need for costly and complex high-voltage installations and multiple transformers, the system 100 reduces costs, streamlines installation, and expands design possibilities in the green and low voltage industries.

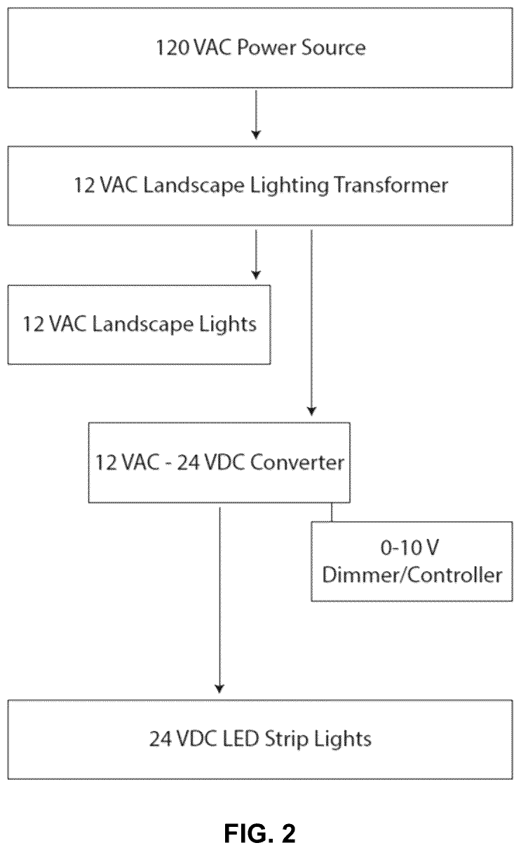

FIG. 2 illustrates a flow of power through the system 100 of FIG. 1. Specifically, power flows from a 120 VAC power source to the transformer 15, which is a 12 VAC transformer. Power flows through the transformer 15 to the plurality of landscape lights 10, directly providing 12 VAC power to the plurality of landscape lights 10. Additionally, power flows through the transformer 15 to the converter 20. The converter 20 converts the 12 VAC power to 24 VDC power and supplies the 24 VDC power directly to the plurality of strip lights 12. The converter 20 also supplies power to the controller 40, which may be a dimmer for controlling a light output of the plurality of strip lights 12. Thus, there are three (3) power levels that flow through the system 100 of FIG. 1: a 120 VAC power level from the power source to the transformer 15; a 12 VAC power level from the transformer 15 to the plurality of landscape lights 10; and a 24 VDC power level from the converter 20 to the plurality of strip lights 12.

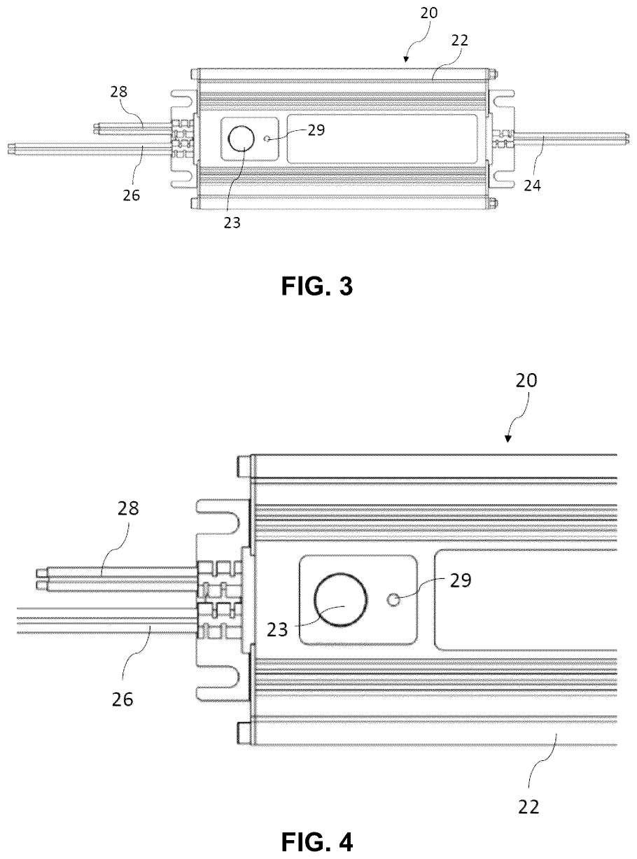

FIGS. 3 and 4 illustrate the converter 20 of the system 100 of FIG. 1. The converter 20 includes a box or housing 22 that features a low-voltage 12 AWG input wire 24 and 18 AWG 24-volt output wires 26 for connection to and powering of the plurality of strip lights. Additionally, the housing 22 may include 18 AWG 0-10V output/dimmer wires 28 for compatibility with 0-10V dimmers or other controllers. For contractors who prefer not to install an external dimmer, the housing 22 may include an on-board dimmer 23 that may be a dimmer button. The dimmer 23 may be a multi-press button having a plurality of states, with each state corresponding to a number of presses of the multi-press button. For example, the default state of the dimmer button (e.g., no or zero presses on the button) may provide a brightness of 100%. A single press of the button may decrease the brightness of the plurality of strip lights to 60%; two presses may further decrease the brightness to 50%; three presses may decrease the brightness to 40%; four presses may decrease the brightness to 30%. Additionally, five presses may decrease the brightness to 20%; six presses may decrease the brightness to 10%; seven presses may decrease the brightness to 8%; eight presses may decrease the brightness to 6%; nine presses may decrease the brightness to 4%; ten presses may decrease the brightness to 2%; and eleven presses may increase the brightness back to 100%. The dimmer 23 may be pressed through this cycle (e.g., 0 to 11 presses) to cycle through the brightness levels for the system 100.

Designed for durability, the housing 22 may be fully potted, making it waterproof and capable of withstanding harsh outdoor conditions. The housing 22 may also include a power indicator light 29 indicating whether the converter 20 is powered for easy troubleshooting and to provide reassurance that the converter 20 is receiving power. Additionally, in some embodiments, the housing 22 and its wires (e.g., input cables 24) may be brown or another suitable shade such as green, to blend seamlessly into outdoor environments. The output/dimmer cables 28 may remain their standard grey and purple colors. The output wires 26 may remain their standard red and black colors.

The converter 20 bridges the gap between the landscape lighting, and landscaping industries, and the electrical specifier world, allowing landscapers and contractors to use 24 VDC strip light products without requiring a licensed electrician. It combines a 12 VAC to 24 VDC converter 20, onboard dimmer 23, and compatibility with 0-10V dimmers into a single, fully potted, waterproof unit designed for outdoor use. The converter 20 includes a power indicator light 29 for troubleshooting and a brown color to blend with outdoor environments, while retaining standard purple and grey dimmer wires. By simplifying the installation process and eliminating the need for multiple components, this all-in-one solution makes 24 VDC strip lighting more accessible and practical for the green industry.

The converter 20 eliminates the need for separate transformers, dimmers, and relays. It reduces costs and complexity by enabling low-voltage wiring without requiring licensed electricians, making it accessible to landscapers and contractors. The power indicator light 23 aids troubleshooting, and the brown design blends seamlessly into outdoor environments, offering a durable, streamlined, and cost-effective solution compared to traditional methods. Furthermore, the converter 20 enables a lighting distribution system (e.g., a landscape lighting distribution) to power 24 VDC strip lighting without introducing line voltage directly from a transformer such that the voltage downstream may be easily controlled.

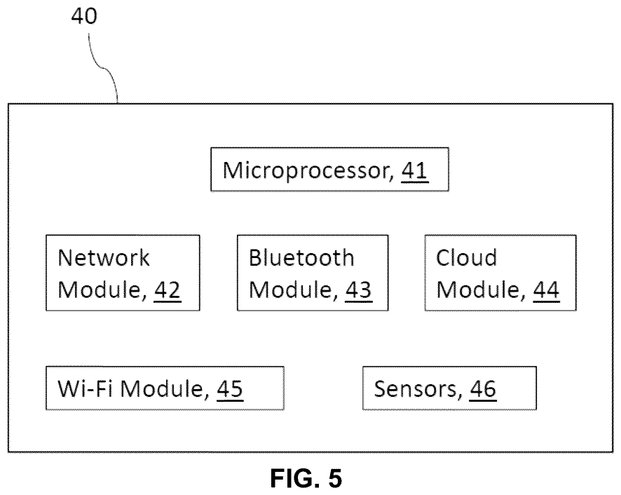

FIG. 5 schematically illustrates a block diagram of the controller 40 for the converter 20. The controller 40 may be incorporated within or housed by the converter 20. The controller 40 may include at least one microprocessor 41 that handles data signals and power output, facilitating the customization of light colors, patterns, and themes for the system 100 and/or individual landscape elements 50. The microprocessor 41 facilitates control of the plurality of strip lights, creating a seamless integration of the plurality of strip lights 12 into the system 100. In some embodiments, the controller 40 may also control the plurality of landscape lights 10 simultaneously to the plurality of strip lights 12. Additionally, the controller 40 may include various modules such as a network module 42, a Bluetooth module 43, a cloud module 44, and a Wi-Fi module 45. The various modules may facilitate communication of the controller 40 with a remote controller (e.g., a software application executed by a mobile device such as a phone or tablet, a remote controller device, etc.). The remote controller may provide instructions, such as light colors, patterns, themes, timers, etc., to the microprocessor 41 which may then control the plurality of strip lights according to the instructions.

Further, the controller 40 may incorporate one or more sensors 46 for detecting conditions about the system 100 (e.g., weather conditions, etc.) and for facilitating control of the plurality of strip lights.

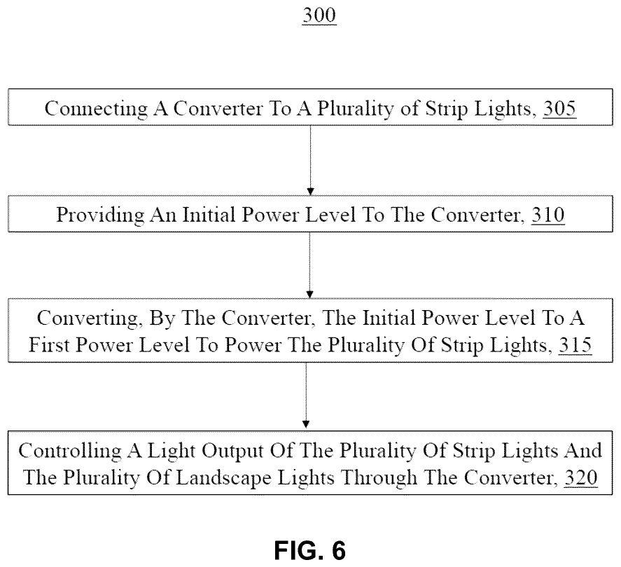

FIG. 6 is a flowchart of a method 300 of powering a lighting system, such as the system 100 of FIG. 1. The method 300 may mirror the flow of power through the system 100 illustrated in FIG. 2. The method may include connecting a converter to a plurality of strip lights, at 305, where the plurality of strip lights are to be installed on a building (e.g., the building itself, stairs, railways, decks, seating areas, walls, wall capstones, etc.). The method 300 may also include providing an initial power level to the converter, at 310, and converting, by the converter, the initial power level to a first power level to power the plurality of strip lights, at 315. Further, the method may include controlling a light output of the plurality of strip lights and the plurality of landscape lights, at 320.

In some embodiments, the method 300 may further include connecting the converter to a transformer that is connected to a power source of the building. The transformer may be plugged directly into the building (e.g., a house) or a component of the building (e.g., a porch, a gazebo, etc.). Converting, by the converter, the initial power level to a first power level to power the plurality of strip lights may include receiving the initial power level ranging from about 11 VAC to about 15 VAC, converting the initial power level to the first power level of about 24 VDC, and supplying the 24 VDC power to the plurality of strip lights. The converter may be the converter 20 of FIGS. 3 and 4. The initial power may be received by the converter 20 through the input wires 24. The 24 VDC power may be delivered to the plurality of strip lights through the output wires 26.

Controlling a light output of the plurality of strip lights through the converter may include actuating a dimmer of the converter and dimming the plurality of strip lights. The plurality of strip lights may be dimmed through the output cables 28.

### Additional Terms and Definitions

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a residential building (e.g., a home); however, other buildings (e.g., commercial buildings, etc.) are also contemplated.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. An outdoor lighting system comprising:
a plurality of strip lights to be installed on a building, the plurality of strip lights powered at a first power level;
a plurality of landscape lights to be installed at a plurality of landscape elements, the plurality of landscape lights powered at a second power level, the second power level being different than the first power level;
a converter in connection with the plurality of strip lights, the converter for providing the first power level to the plurality of strip light; and
a controller for controlling a light output of the plurality of strip lights.

2. The outdoor lighting system of claim 1, wherein the outdoor lighting system is GFCI rated.

3. The outdoor lighting system of claim 1, wherein the first power level comprises 24 VDC and the second power level comprises 12 VAC.

4. The outdoor lighting system of claim 3, wherein the converter supplies the plurality of strip lights with 24 VDC, and further comprising a transformer for providing the plurality of landscape lights with 12 VAC.

5. The outdoor lighting system of claim 1, wherein the controller controls a dimness of the plurality of strip lights.

6. The outdoor lighting system of claim 1, wherein the light output of the plurality of strip lights comprises one or more of a dimness, a color, and a pattern.

7. The outdoor lighting system of claim 1, wherein the outdoor lighting system does not need to be installed by an electrician.

8. The outdoor lighting system of claim 1, wherein the plurality of strip lights are installed on a residential building.

9. The outdoor lighting system of claim 8, wherein the converter is installed at the residential building and connects to an electrical grid of the residential building.

10. The outdoor lighting system of claim 1, further comprising a plurality of connectors for connecting the plurality of strip lights to the converter.

11. A lighting system comprising:
a plurality of strip lights to be installed on a building;
a plurality of landscape lights to be installed at landscape elements about the building;
a converter in electrical connection with the plurality of strip lights, the converter for supplying power to the plurality of strip lights; and
a controller for controlling a light output of the plurality of strip lights.

12. The lighting system of claim 11, wherein the controller is housed within the converter.

13. The lighting system of claim 11, further comprising a remote device for sending instructions to the controller, the instructions comprising the light output.

14. The lighting system of claim 11, wherein the converter converts a power level of about 11 V to about 15 VAC to about 24 VDC and supplies the about 24 VDC to the plurality of strip lights.

15. The lighting system of claim 11, wherein the controller comprises a dimmer for controlling the light output of the plurality of strip lights.

16. The lighting system of claim 15, wherein the dimmer comprises a multi-press button having a plurality of states, with each state corresponding to a number of presses of the multi-press button.

17. A method of powering strip lights, the method comprising:
connecting a converter to a plurality of strip lights, the plurality of strip lights to be installed on a building;
providing an initial power level to the converter;
converting, by the converter, the initial power level to a first power level to power the plurality of strip lights;
powering the plurality of strip lights at the first power level; and controlling a light output of the plurality of strip lights.

18. The method of claim 17, further comprising connecting the converter to a 12 VAC transformer.

19. The method of claim 17, wherein converting, by the converter, the initial power level to a first power level to power the plurality of strip lights comprises:
receiving the initial power level ranging from about 11 VAC to about 15 VAC; converting the initial power level to the first power level of about 24 VDC; and supplying the 24 VDC power to the plurality of strip lights.

20. The method of claim 17, wherein controlling a light output of the plurality of strip lights comprises:
actuating a dimmer of the converter; and dimming the plurality of strip lights.
